(19) United States
(12) Patent Application Publication
(10) Pub. No.: US 2007/0086050 A1
(43) Pub. Date: Apr. 19, 2007

(54) INFORMATION PROCESSING APPARATUS, IMAGE PROCESSING METHOD, AND MACHINE-READABLE MEDIUM

(75) Inventor: Hiroshi Matsuda, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/534,024

(22) Filed: Sep. 21, 2006

(30) Foreign Application Priority Data
Oct. 14, 2005 (JP) 2005-300782

(51) Int. Cl. G06F 3/12

(52) U.S. Cl. 358/1.15; 358/1.14

(57) ABSTRACT

An apparatus includes an analysis unit configured to analyze a content of change in a print setting when a change in the print setting is set between pages of print data, a determination unit configured to determine whether there is a discrepancy in a relationship between the content of change in the print setting and the associated pages of the print data, and a notification unit configured to notify a warning indicating the change to a user if it is determined that there is a discrepancy in the relationship between the content of change in the print setting and the associated pages of the print data.

### BACKGROUND OF THE INVENTION

1. Field of the Invention

The present invention relates to an information processing apparatus, an image processing method, and a machine-readable medium, and more specifically relates to a method in which a content of print data is verified and then the print data is output.

2. Description of the Related Art

Conventionally, a page printer receives print data described in a page description language (PDL) via a communication medium such as a network. In addition, the page printer interprets the received print data by using a dedicated interpreter, and after that, performs a raster image processor (RIP) processing for forming an image. Finally, the page printer prints out the formed image by using a printer engine such as an electrophotographic printer engine. The print data described in a page description language is produced by using an original electronic document by a cooperated operation of an application, an operating system, and a driver. For the page description language, LIPS developed by Canon Inc., PCL developed by Hewlett-Packard Development Company, L.P., PostScript developed by Adobe Systems Incorporated, and ESC/P developed by SEIKO EPSON Corporation are widely known. In addition to the page printer as described above, there is a printer that receives an electronic document itself such as a PDF developed by Adobe Systems Incorporated and performs an RIP processing on the received electronic document.

In addition, there is a job ticket, which is a component that configures print data, as well as PDL data and electronic document data. The job ticket is commonly used to notify detailed parameters used in RIP processing and post processing to a printer. With the job ticket, a designation can be performed for a setting for a medium and various processing such as a layout processing, various kinds of finishing processings, a color management using an International Color Consortium (ICC) profile, and various kinds of color conversion processings. In addition, with the job ticket, a content of processing can be designated for each page or for each arbitrary page section of PDL data or electronic document data to be printed.

Meanwhile, in print service shops, a service for printing received print data such as PDF and PS is widely used. In such a service, a preflight check is performed for the received print data by an operator using a printing system. The preflight check refers to an operation for checking if the print data is in a state conforming to printing rules in advance of a main printing. The preflight check is performed in order to alleviate a miss printing at the time of the main printing. Items to be checked by the preflight check includes the type of fonts included in the print data, the embedding of fonts, a color space and a resolution of image data, and a designation for a color profile. Japanese Patent Application Laid-Open No. 2000-280435, for example, discusses such a technology. The preflight check is often performed by dedicated application software. However, recently, there is a page printer that includes a preflight checking function. As described above, with the preflight check, an inadequacy in PDL data or electronic document data can be checked.

However, in the conventional preflight check, an inadequacy such as a mismatch occurring between a job ticket and PDL data or electronic document data cannot be checked. Especially in the case where a detailed processing content is designated by the job ticket for each page or for each arbitrary page section of PDL data or electronic document data to be printed, a mismatch between the job ticket and the PDL data or electronic document data is likely to occur. In a common printer driver or a job submitter such as a hot folder, a designation for the processing content cannot be easily performed while looking at each page of an original. Thus, a displacement or a difference is likely to occur between the page specified for processing by a user and the page of the original intended by the user to be processed.

As described above, in the conventional technology, when a print setting is changed in a mid-way portion of print data, the print data may possibly be output in a form that the user does not desire.

### SUMMARY OF THE INVENTION

The present invention is directed to avoiding or at least mitigating outputting of print data in a form that a user does not desire occurring due to changes in a print setting for two consecutive pages of the print data.

According to an aspect of the present invention, an apparatus includes an analysis unit, a determination unit, and a notification unit. The analysis unit is configured to analyze a content of change in a print setting when a change in the print setting is set between pages of print data. The determination unit is configured to determine whether there is a discrepancy in a relationship between the content of change in the print setting and the associated pages of the print data. The notification unit is configured to notify a warning indicating the change to a user if it is determined that there is a discrepancy in the relationship between the content of change in the print setting and the associated pages of the print data.

According to another aspect of the present invention, a method includes: analyzing a content of change in a print setting when a change in the print setting is set between pages of print data; determining whether there is a discrepancy in a relationship between the content of change in the print setting analyzed and the associated pages of the print data; and notifying a warning indicating the change to a user if it is determined that there is a discrepancy in the relationship between the content of change in the print setting and the associated pages of the print data.

According to yet another aspect of the present invention, there is provided a machine-readable medium storing instruction which, when executed by a machine, causes the machine to perform operations including: analyzing a content of change in a print setting when a change in the print setting is set between pages of print data; determining whether there is a discrepancy in a relationship between the content of change in the print setting analyzed and the associated pages of the print data; and notifying a warning indicating the change to a user if it is determined that there is a discrepancy in the relationship between the content of change in the print setting and the associated pages of the print data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the designation, illustrate embodiments of the invention and, together with the description, serve to explain the principles of the invention.

FIG. 1 is a block diagram illustrating an overall configuration of a document processing system according to a first exemplary embodiment of the present invention.

FIG. 2 is a block diagram illustrating an example of a configuration of a document processing device according to the first exemplary embodiment of the present invention.

FIG. 3 is a diagram illustrating an example of an exterior configuration of the document processing device according to the first exemplary embodiment of the present invention.

FIG. 4 is a diagram illustrating an example of an operation unit of the document processing device according to the first exemplary embodiment of the present invention.

FIG. 5 is a block diagram illustrating an example of a software configuration of the document processing device according to the first exemplary embodiment of the present invention.

FIG. 6 is a diagram schematically illustrating a flow of an RIP processing for interpreting a page description language and forming an image according to the first exemplary embodiment of the present invention.

FIG. 7 is a diagram illustrating an example of RIP detailed parameters according to the first exemplary embodiment of the present invention.

FIG. 8 is a diagram illustrating an example of a job ticket that serves as a base of the RIP detailed parameters according to the first exemplary embodiment of the present invention.

FIG. 9 is a diagram illustrating an example of a warning that is displayed by a liquid crystal display (LCD) provided on the operation unit according to the first exemplary embodiment of the present invention.

FIG. 10 is a flow chart illustrating an example of a processing by a color determination unit according to the first exemplary embodiment of the present invention.

FIG. 11 is a flow chart illustrating an example of a processing by a color-related preflight checking unit according to the first exemplary embodiment of the present invention.

FIGS. 12A through 12H are diagrams illustrating an example of a result of the determination as to appropriateness of a designation of a color processing according to the first exemplary embodiment of the present invention.

FIG. 13 is a diagram illustrating an example of a table for determining the appropriateness of the designation of the color processing according to the first exemplary embodiment of the present invention.

FIGS. 14A and 14B are diagrams illustrating an example in which although an image that is produced by the RIP processing is changed, the appropriateness of a job is doubtful according to a second exemplary embodiment of the present invention.

FIG. 15 is a diagram illustrating an example of a screen displayed by the LCD provided on the operation unit according to the second exemplary embodiment of the present invention.

FIG. 16 is a diagram schematically illustrating a flow of an RIP processing for interpreting a page description language and forming an image according to the second exemplary embodiment of the present invention.

FIG. 17 is a flow chart illustrating an example of a processing of a color determination unit according to the second exemplary embodiment of the present invention.

FIG. 18 is a flow chart illustrating an example of a processing of a color-related preflight checking unit according to the second exemplary embodiment of the present invention.

FIG. 19 is a diagram illustrating an example of a flow from the issuance of a print instruction to an application by a user to the printing out according to a third exemplary embodiment of the present invention.

FIG. 20 is a diagram illustrating an example of a configuration of a preflight module for determining the appropriateness of a setting for the designation of color processing.

FIG. 21 is a block diagram illustrating an example of a configuration of a host computer according to an exemplary embodiment of the present invention.

### DETAILED DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

First Exemplary Embodiment

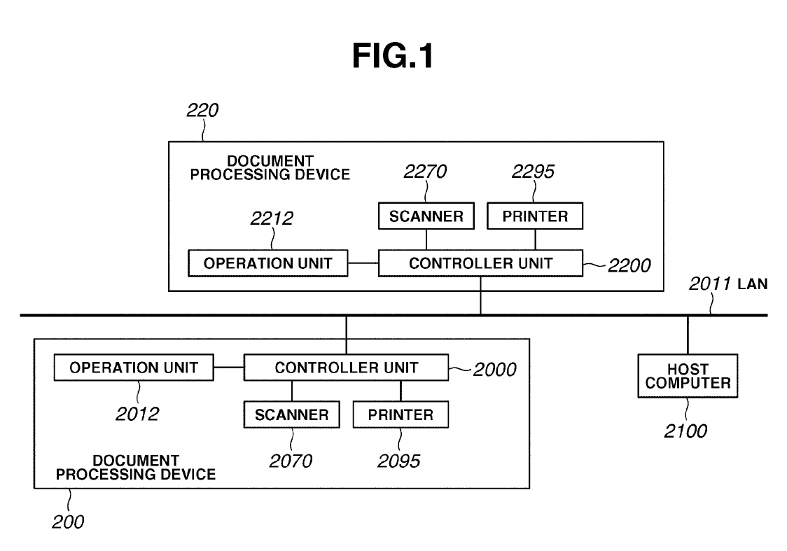

FIG. 1 is a block diagram illustrating an example of an overall configuration of a document processing system according to a first exemplary embodiment of the present invention. A document processing device 200 includes a scanner 2070 that is an image input device, a printer 2095 that is an image output device, a controller unit 2000, and an operation unit 2012 that is a user interface.

Each of the scanner 2070, the printer 2095, and the operation unit 2012 is connected to the controller unit 2000. The controller unit 2000 is connected to a network transmission unit such as a LAN 2011. In addition, another document processing device 220 that has a similar device configuration as the document processing device 200 is connected to the LAN 2011. The document processing device 220 includes a scanner 2270, a printer 2295, and an operation unit 2212, each of which is connected to a controller unit 2200. In addition, a host computer 2100 is connected to the LAN 2011.

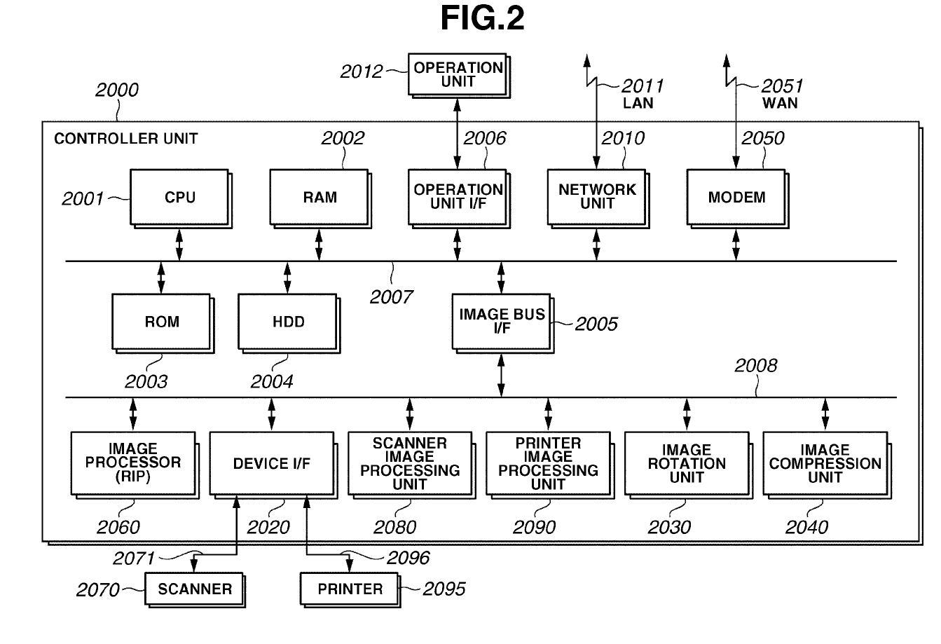

FIG. 2 is a block diagram illustrating an example of a configuration of the document processing device 200. Referring to FIG. 2, the controller unit 2000 is connected to the scanner 2070 that is an image input device and the printer 2095 that is an image output device. In addition, the controller unit 2000 is connected to the LAN 2011 and a public line (WAN) 2051. With the connection of devices and units as described above, the controller unit 2000 can input and output image information and device information.

A CPU 2001 is a controller that controls the entire system. A RAM 2002 is a work memory for allowing the CPU 2001 to operate. In addition, the RAM 2002 is an image memory for temporarily storing image data. A ROM 2003 is a boot ROM, which stores a boot program of the system. A hard disk drive (HDD) 2004 stores system software and image data. An operation unit interface (I/F) 2006 is an interface between an operation unit (UI) 2012 and the controller unit 2000. The operation unit I/F 2006 outputs image data that is displayed by the operation unit 2012 to the operation unit 2012. In addition, the operation unit I/F 2006 transmits information input by a user of the document processing device 200 via the operation unit 2012 to the CPU 2001.

A network unit 2010 is connected to the LAN 2011 and sends and receives information to and from an external device. A modem 2050 is connected to the WAN (public line) 2051 and sends and receives information to and from an external device. The devices as described above are disposed on a system bus 2007. An image bus I/F 2005 mutually connects the system bus 2007 and an image bus 2008 that transmits image data at a high speed. The image bus I/F 2005 is a bus bridge that converts a configuration of the input data. The image bus 2008 includes a PCI bus or an IEEE 1394 bus. Devices as described below are connected to the image bus 2008.

An image processor (RIP) 2060 rasterizes a display list into a raster image. A device I/F 2020 mutually connects the scanner 2070 and the printer 2095 that are the image input/output device and the controller unit 2000. The device I/F 2020 converts synchronous image data into asynchronous image data, and also converts asynchronous image data into synchronous image data. A scanner image processing unit 2080 performs a correction, an image processing, and an editing on input image data. A printer image processing unit 2090 performs a correction, a conversion of resolution, and a halftoning for the printer with respect to image data to be printed out. An image rotation unit 2030 rotates image data. An image compression unit 2040 performs a processing for compressing and decompressing continuous tone image data into JPEG format image data, for example. In addition, the image compression unit 2040 compresses binary image data into data such as JBIG, MMR, and MH data and carries out a decompression processing on the compressed data.

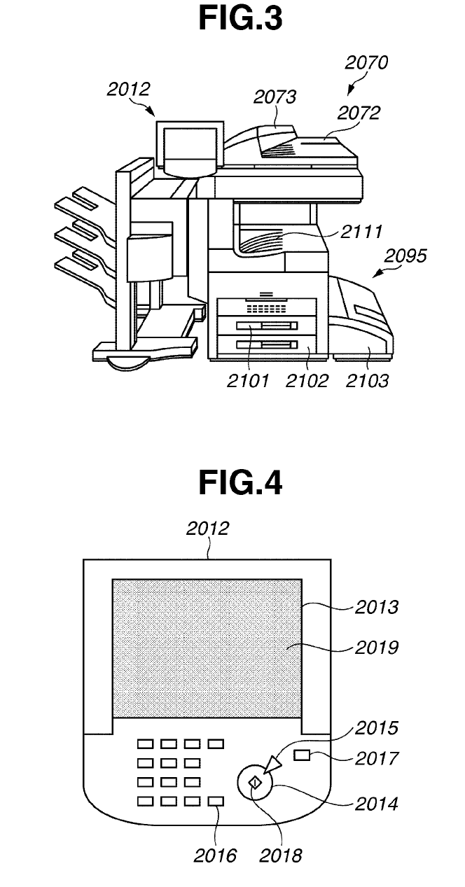

FIG. 3 is a diagram illustrating an example of an exterior configuration of the document processing device 200. The scanner 2070, which is an image input device, illuminates an image on an original paper sheet and moves a CCD line sensor (not shown) so as to convert the image on the original paper sheet into raster image data (electrical signal) 2071. The original paper sheet is set onto a tray 2073 of a document feeder 2072. When a user of the document processing device 200 instructs a start of processing for reading the image on the original paper sheet via the operation unit 2012, an instruction for producing the raster image data 2071 is sent to the scanner 2070. The document feeder 2072 feeds the original paper sheet one by one. Thus, the operation of reading the image on the original paper sheet starts.

The printer 2095, which is an image output device, is a portion that converts raster image data 2096 into an image on a printing paper sheet. For the method of converting the raster image data 2096 into the image on the printing paper sheet, there are an electrophotographic system that uses a photosensitive drum or a photosensitive belt and an ink jet system in which ink is discharged from a minute nozzle array so as to directly print the image onto the printing paper sheet. The method of converting the raster image data 2096 into the image on the printing paper sheet may be any of the methods described above. The printing operation starts upon receiving an instruction for converting an image issued from the CPU 2001. The printer 2095 is provided with a plurality of paper feeding stages so that different paper sizes and different paper orientations can be selected. The printer 2095 includes paper cassettes 2101, 2102, and 2103 corresponding to the plural paper feeding stages. A paper discharge tray 2111 receives a paper sheet on which printing is completed.

FIG. 4 is a diagram illustrating an example of the operation unit 2012 of the document processing device 200. Referring to FIG. 4, an LCD display unit 2013 includes a liquid crystal display (LCD) and a touch panel sheet 2019 that is attached onto the LCD. The LCD display unit 2013 displays an operation screen and soft keys of the system and sends positional information of a key to the CPU 2001 when the key is pressed. A “start” key 2014 is operated by the user of the document processing device 200 in starting the reading operation of an original image. In a center portion of the “start” key 2014, a two-color (green and red) light-emitting diode (LED) 2018 is provided. The color of the LED 2018 indicates whether the “start” key 2014 is in a usable state or not. A “stop” key 2015 is operated by the user of the document processing device 200 in stopping the operation that is currently being performed. An “ID” key 2016 is used in inputting a user ID of the user of the document processing device 200. A “reset” key 2017 is operated by the user of the document processing device 200 in initializing the setting set through the operation unit 2012.

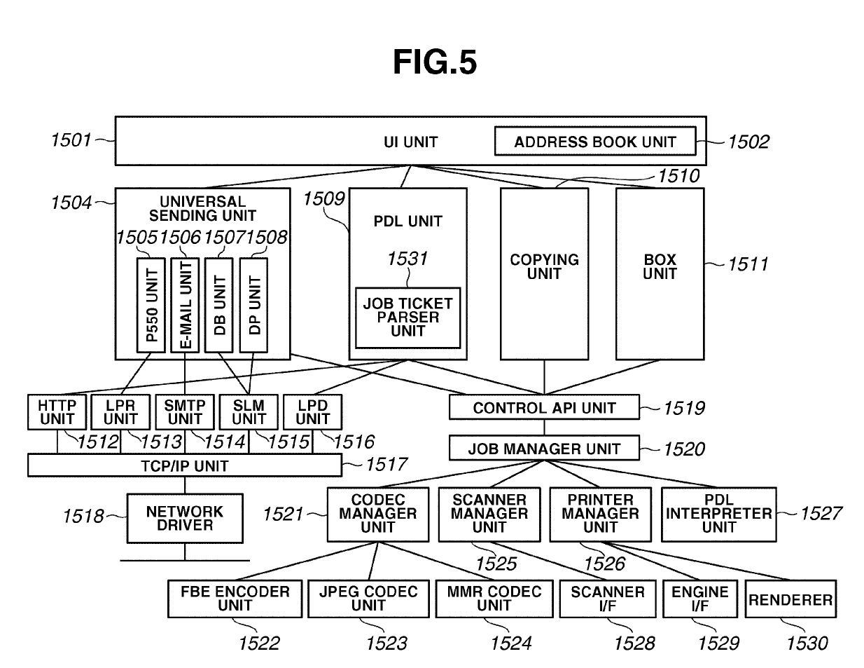

FIG. 5 is a block diagram illustrating an example of a software configuration of the document processing device 200. Referring to FIG. 5, a UI unit 1501 transmits input information to various kinds of modules, which are to be described later below, in accordance with the operation through the operation unit 2012 by the user so as to request a processing to be performed and perform a setting of data. The UI unit 1501 controls the user interface. The UI unit 1501 is a module that intervenes between the user and the document processing device 200 when the user performs various operations and settings of the document processing device 200. An address book unit 1502 is a data base module that manages a transmission destination of data and a communication destination by using an address book. Contents of the address book are added, erased, and changed based on operational information of the operation unit 2012 input by the UI unit 1501. In addition, the address book unit 1502 sends data and notifies information on the communication destination to each of the modules described below, based on the operational information of the operation unit 2012.

A universal sending unit 1504 is a module that controls a distribution of data. The universal sending unit 1504 distributes the input information that is output from the UI unit 1501 (that is, data that is instructed by the user via the operation unit 2012) to a communication (output) destination that is instructed likewise by the operation of the operation unit 2012 by the user. The universal sending unit 1504, when an instruction for producing data by using the scanner 2070 is made by the operation of the operation unit 2012 by the user, allows the document processing device 200 to operate via a control API unit 1519 so as to produce data. A P550 unit 1505 is a module that is executed when the printer 2095 is designated as an output destination in the universal sending unit 1504.

An E-mail unit 1506 is a module that is executed when an e-mail address is designated as the communication destination in the universal sending unit 1504. A DB unit 1507 is a module that is executed when a database is designated as the output destination in the universal sending unit 1504. A DP unit 1508 is a module that is executed when the document processing device 220 that has the same configuration as the document processing device 200 is designated as the output destination in the universal sending unit 1504.

A PDL unit 1509 is a module for implementing a function for printing PDL data that is described by using a page description language (PDL) that is externally transmitted, by using a printing function of the document processing device 200. A job ticket parser unit 1531 in the PDL unit 1509 is a module for interpreting job ticket data that is received together with the PDL data. With the job ticket, a designation can be made as to information (print setting) concerning a print medium, a number of copies to make, a post processing, various kinds of color processings, and an image processing method. The information that can be designated is analyzed by the job ticket parser unit 1531. Then, the information described above is transmitted to a job manager unit 1520, a print manager unit 1526, and a PDL interpreter unit 1527 via the control API unit 1519. In addition, the PDL unit 1509 provides a function for pulling an electronic document that is stored in an external web server by using an HTTP unit 1512 so as to print the electronic document.

A copying unit 1510 is a module for performing a copying operation in accordance with the instruction from the UI unit 1501, by using the function of the printer 2095 and the function of the scanner 2070 of the document processing device 200. A box unit 1511 stores various kinds of images such as a scanning image and a PDL print image into the HDD 2004. The stored image is printed by using the function of the printer 2095 and sent by using the function of the universal sending unit 1504. In addition, the box unit 1511 provides a management function such as a deletion, a grouping (storage into each box), a movement between the boxes, and the copying between boxes, of the documents stored in the HDD 2004.

The HTTP unit 1512 is a module that is used when the document processing device 200 performs a communication by using the HyperText Transfer Protocol (HTTP). The HTTP unit 1512 provides a communication to the PDL unit 1509 described above by a TCP/IP unit 1517 to be described below. A line printer daemon protocol (LPR) unit 1513 is a module that provides a communication to the P550 unit (printer module) 1505 in the universal sending unit 1504 described above by the TCP/IP unit 1517 to be described below. An SMTP unit 1514 is a module that provides a communication to the E-mail unit 1506 in the universal sending unit 1504 described above by the TCP/IP unit 1517 to be described below. A salutation manage (SLM) unit 1515 is a module that provides a communication to the DB unit 1507 and the DP unit 1508 in the universal sending unit 1504 described above by the TCP/IP unit 1517 to be described below.

An LPD unit 1516 is a module that provides a communication to the PDL unit 1509 described above by the TCP/IP unit 1517 to be described below. The TCP/IP unit 1517 is a communication module that provides a network communication to various kinds of modules described above, by a network driver 1518 to be described below. The network driver 1518 controls a portion of the document processing device 200 that is physically connected to a network.

The control API unit 1519 is a module that provides an interface between a higher-level module and a lower-level module. The control API unit 1519 reduces a mutual dependency between the higher-level module and the lower-level module so as to improve a versatility of each of the higher-level module and the lower-level module. Here, the higher-level module includes, for example, the universal sending unit 1504, the PDL unit 1509, the copying unit 1510, and the box unit 1511. The lower-level module includes, for example, the job manager unit 1520 to be described below.

The job manager unit 1520 is a module that interprets the processing instructed from various kinds of modules via the control API unit 1519 and instructs each module to be described below to perform the interpreted processing. In addition, the job manager unit 1520 unitarily manages the processing in terms of hardware that is performed in the document processing device 200. A CODEC manage unit 1521 manages and controls various kinds of compression and decompression of data in accordance with the processing instructed by the job manager unit 1520.

An FBE encoder unit 1522 compresses data read by a scanning processing performed by the job manager unit 1520 and a scanner manager unit 1525 into an FBE format. A JPEG CODEC unit 1523 performs a JPEG compression of data read by the scanning processing performed by the job manager unit 1520 and the scanner manager unit 1525 and a JPEG decompression processing of the print data. In addition, the JPEG CODEC unit 1523 performs the JPEG compression of the data read in the course of the print processing performed by the print manager unit 1526 and the JPEG decompression processing of the print data. An MMR CODEC unit 1524 performs an MMR CODEC compression of the print data that is read by the scanning processing performed by the job manager unit 1520 and the scanner manager unit 1525 and an MMR CODEC decompression processing of the print data. In addition, the MMR CODEC unit 1524 performs the MMR CODEC compression of the data that is read in the course of the print processing by the print manager unit 1526 and the MMR CODEC decompression processing of the print data.

The scanner manage unit 1525 is a module that manages and controls the scanning processing that is instructed by the job manager unit 1520. A scanner I/F 1528 provides an interface between the MMR CODEC unit 1524 and the scanner 2070. The print manager unit 1526 is a module that manages and controls the print processing instructed by the job manager unit 1520. An engine I/F 1529 provides an interface between the print manager unit 1526 and the printer 2095.

The PDL interpreter unit 1527 is a module for interpreting a PDL such as LIPS, PostScript, PCL, PDF, and SVG or an electronic document format, in accordance with the instruction from the job manager unit 1520. The PDL interpreter unit 1527 produces a display list that is a common representation format that can be used independently of the kind of the PDL and the electronic document format. A renderer 1530 rasterizes the display list produced by the PDL interpreter unit 1527 into a raster image memory by using an image processor, in accordance with the instruction from the print manager unit 1526.

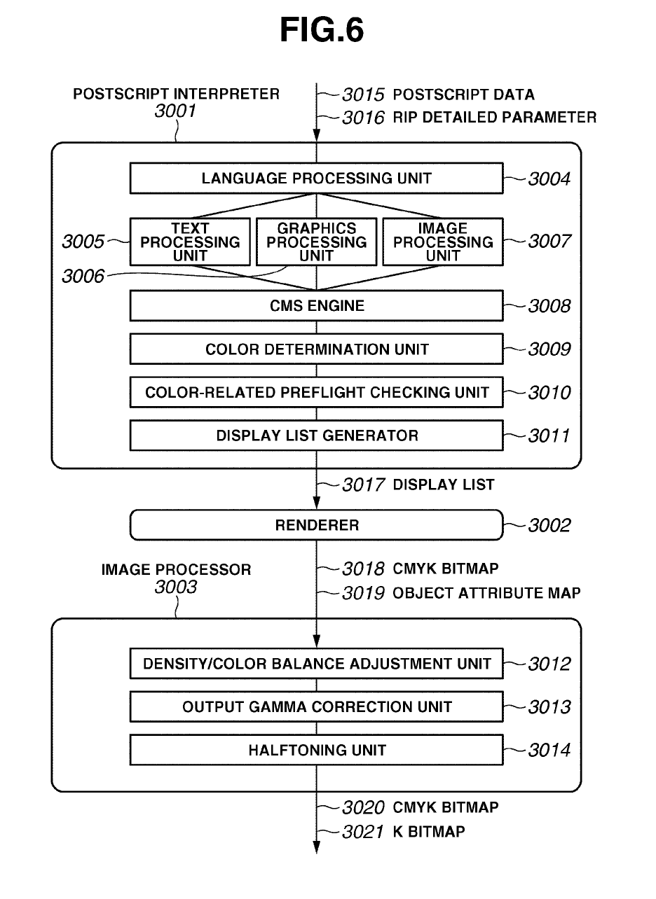

FIG. 6 is a diagram schematically illustrating a flow of an RIP processing for interpreting a page description language and forming an image. Referring to FIG. 6, a PostScript interpreter 3001 is an example of the PDL interpreter unit 1527 shown in FIG. 5. The PostScript interpreter 3001 interprets the data described in the PostScript Language and produces a display list 3017 that is intermediate language data. Note that each module in the PostScript interpreter 3001 is executed in pipelines. That is, each of the modules 3004 through 3011 is repeatedly executed for each rendering object, and when the processing for all the rendering objects in one page is completed, the display list for one page is produced.

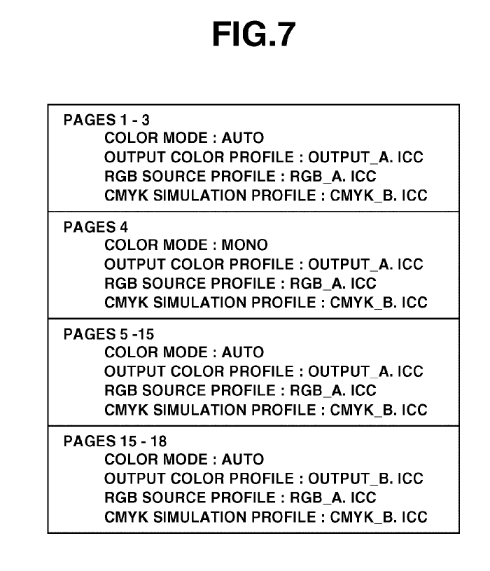

RIP detailed parameters 3016 are parameters that are applied when the information that is designated by the job ticket describes a performance of the RIP processing. The RIP detailed parameters 3016 provided here include parameters for, for example, an output color mode, an RGB source profile, a CMYK simulation profile, and an output profile. In addition, as shown as an example in FIG. 7, the RIP detailed parameters 3016 are designated for each page or for each arbitrary page section in some cases.

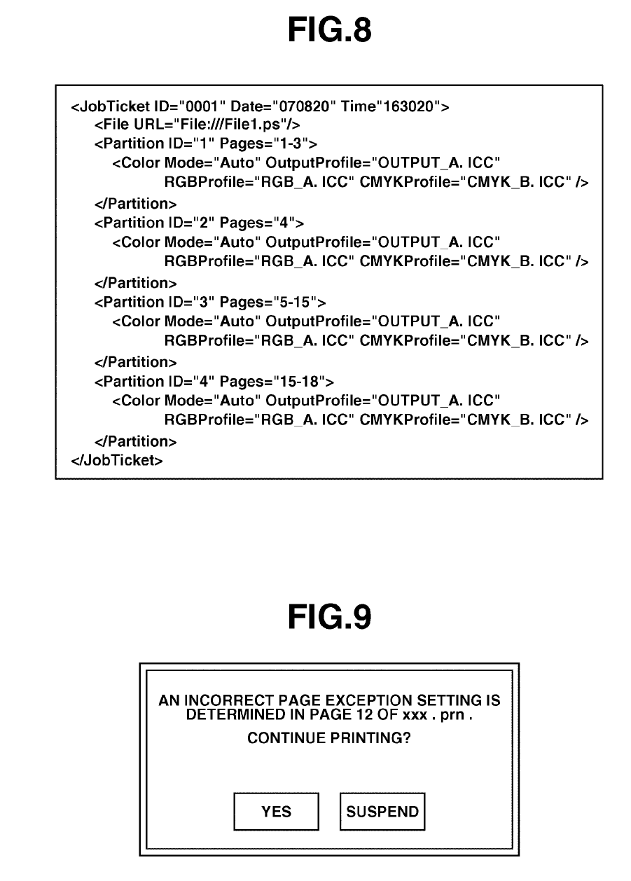

FIG. 8 is a diagram illustrating an example of the job ticket that serves as a base of the RIP detailed parameters 3016. The job ticket is, as described above, interpreted by the job ticket parser unit 1531 shown in FIG. 5. Note that in the flow of the RIP processing shown in FIG. 6, the description is made on a premise that the setting for the output color mode that is the mode for determining whether all portions of the page is color or monochromatic depending on the color of the rendering object included in each page is set to be “auto”.

Referring back to FIG. 6, a language processing unit 3004 interprets PostScript data 3015, and issues a rendering request to at least one of rendering processing units including a text processing unit 3005, a graphics processing unit 3006, and an image processing unit 3007, based on a content that is interpreted. The text processing unit 3005 produces a character bitmap from a designated font. The graphics processing unit 3006 controls a vector graphics rendering. The image processing unit 3007 performs the processing for converting image data into a common internal data format.

A CMS engine 3008 is a module for performing a color management. The CMS engine 3008 converts an input color into a color of an absolute color space, and then produces output colors (C, M, Y, K) that are unique to a printer engine. In the PostScript language, various kinds of color spaces are defined. The color space includes, for example, a device color space, a CIE-based color space, and a specialized color space. With respect to the input colors that are designated in the device color space, the color is converted by using designated ICC profiles among previously provided ICC profiles such as the RGB source profile and the CMYK simulation profile. With respect to the input colors that are designated in the CIE-based color space, the color conversion is performed in accordance with a conversion table, a conversion function, or a conversion matrix designated for the color space. The conversion from the absolute color space to the color space unique to the printer engine is performed by using the output profile or a color rendering dictionary that is defined in the PostScript. For the output profile, a gray compensation profile, which prioritizes a reproduction of a gray scale in a single color of K (black), and a normal profile, which reproduces the gray scale with four colors of C, M, Y, and K, can be selectively used. Specific colors that are designated in a separation color space or a Device N color space are converted into process colors (C, M, Y, and K) by using a named ICC profile.

A color determination unit 3009 checks output colors (C, M, Y, and K) that are output values of the CMS engine 3008 and determines whether the page that is currently being processed is a color page or a monochromatic page. The color determination is performed only when the setting for the output color mode is designated to be “auto” by the output color mode of the RIP detailed parameters 3016. In addition, for the output color mode, “color” and “monochromatic” can be designated. When the “color” or the “monochromatic” is designated for the output color mode, the color determination is not performed. A detailed description as to the method of color determination is described below.

A color-related preflight checking unit 3010 determines an appropriateness of the designation for color processing by the job ticket when the setting for the profile designated by the RIP detailed parameters 3016 is changed from the setting for a previous page. In the present embodiment, the appropriateness of the designation for the color processing by the job ticket is determined based on whether the setting for the changed profile affects an image to be formed. Note that the method of determining the appropriateness of the designation of the color processing by the job ticket and the ground of the determination are to be described below. When it is determined by the color-related preflight checking unit 3010 that the appropriateness of the designation of the color processing by the job ticket is doubtful, the RIP processing is temporarily suspended, and a warning to the effect that a doubtful job is input is displayed by the LCD provided on the operation unit 2012. Then, the color-related preflight checking unit 3010 waits until an instruction for continuing the processing or suspending the processing is input by the user via the operation unit 2012. When the instruction for continuing the processing is issued by the user via the operation unit 2012, the RIP processing restarts from a suspended state. On the other hand, if the suspension of the processing is instructed by the user via the operation unit 2012, the job is cancelled. That is, the RIP processing thereafter is not performed.

FIG. 9 is a diagram illustrating an example of the warning that is displayed by the LCD provided on the operation unit 2012. In the example shown in FIG. 9, it is displayed by the LCD that a relationship between the print data of page 12 and the print setting for page 12 is incorrect. Note that a sequence of the suspension of the RIP processing, an inquiry as to whether the RIP processing is continued or not, and the restart or the suspension of the RIP processing is performed by controlling the UI unit 1501 via the print manager unit 1526 and the job manager unit 1520. In addition, with respect to the job whose designation of the color processing is determined to be doubtful, “NG” is recorded on a print job history as a result of the preflight checking, and then the result is stored as a log.

A display list generator 3011 produces the display list 3017, which is intermediate language data. In addition, an attribute flag of each object is included in the display list 3017. The attribute flag enables a discrimination as to whether the object is a graphic, an image, or a character. Each attribute is notified from the image processing unit 3007, the CMS engine 3008, and the color determination unit 3009. The attribute flag is used by an image processor 3003 at a later stage via a renderer 3002. In addition, the display list 3017 includes raster operation information of each object. With the raster operation information, it is discriminated whether the object needs the raster operation processing.

The renderer 3002 interprets the display list 3017 and produces a CMYK bitmap 3018 whose bit depth is 8×4 for each plane. The renderer 3002 performs most processings by using the image processor (RIP) 2060 shown in FIG. 2. Note that the renderer 3002 corresponds to the renderer 1530 shown in FIG. 5. The renderer 3002 includes a raster operation mode such as a mask (result=src|dest) mode, a copy (result=src) mode, and a merge (result=src|dest) mode. In addition, the renderer 3002 performs the raster operation processing between the rendering object that is already rendered (background: dest) and the rendering object that is to be rendered next (foreground: src), in accordance with the raster operation mode designated for each rendering object. In addition, a result of rendering that is a result of the raster operation processing is rasterized on a page memory.

In addition, the renderer 3002 produces an object attribute map 3019 as a fifth version based on an attribute flag included in the display list 3017. Here, the object attribute map 3019 represents the attribute for each pixel of each device, and has attribute information of the bit depth of 2 (graphics: 01; image: 10; and character: 11) for each pixel. The CMYK bitmap 3018 and the object attribute map 3019 produced as described above are sent to the image processor 3003.

The image processor 3003 performs an image processing on the CMYK bitmap 3018 that is produced by the renderer 3002. The image processing includes, for example, an adjustment of density and a color balance performed by a density/color balance adjustment unit 3012, gamma-correction performed by an output gamma correction unit 3013, and halftoning performed by a halftoning unit 3014. Note that the image processor 3003 is controlled by the print manager unit 1526 shown in FIG. 5.

The halftoning unit 3014 applies a halftoning differently to each attribute of the object with reference to the object attribute map 3019. More specifically, with respect to an image area of a graphics attribute, the halftoning unit 3014 applies a high number of lines per inch screen that prioritizes the resolution. In addition, with respect to an image area of an image attribute, the halftoning unit 3014 applies a low resolution screen that prioritizes a gradation. In addition, with respect to an image area of a character attribute, the halftoning unit 3014 applies an error diffusion. When the page is determined to be a monochromatic page by the color determination unit 3009, only the bitmap of a version K among the CMYK bitmap 3018 produced by the renderer 3002 is sent to the image processor 3003. Then, a K bitmap 3021 that is used in a final output is produced by the image processor 3003. On the other hand, when the page is determined to be a color page by the color determination unit 3009, the CMYK bitmap 3018 produced by the renderer 3002 is sent as it is to the image processor 3003. Then, a CMYK bitmap 3020 that is used in the final output is produced by the image processor 3003. Thus, the CMYK bitmap 3020 or the K bitmap 3021 that is produced by the image processor 3003 is transmitted to the printer engine (the scanner 2070) via the engine I/F 1529 shown in FIG. 5, so as to be printed out onto a desired medium.

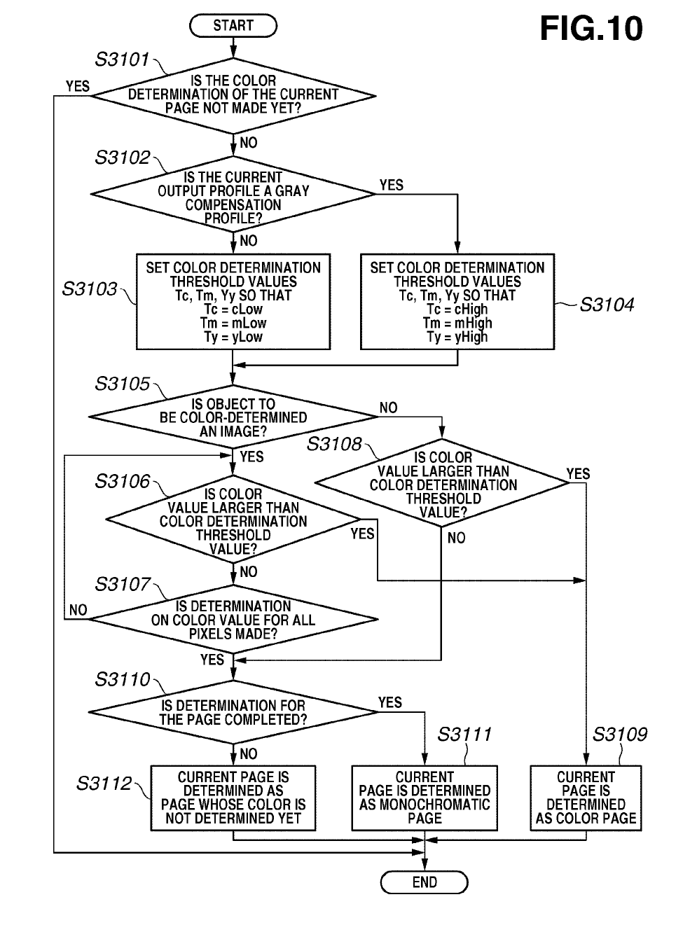

An example of a processing executed by the color determination unit 3009 shown in FIG. 6 is described in more detail below with reference to the flow chart of FIG. 10. In the present embodiment, the color management processing, the color determination processing, the color-related preflight checking processing, and the display list production processing are performed in this order for each rendering object. Thus, the flow chart shown in FIG. 10 is called for each rendering object as a color determination routine.

First, in step S3101, it is determined whether the color determination for a current page is not made yet. If, as a result of the determination, it is determined that the current page is already determined to be a color page or a monochromatic page, the color determination is not performed and the processing ends. On the other hand, if it is determined that the color determination of the current page is not made yet, the processing advances to step S3102. In step S3102, it is determined whether the output profile that is currently selected is a gray compensation profile. If, as a result of the determination, it is determined that the output profile that is currently selected is a gray compensation profile, the processing advances to step S3104. If it is determined that the output profile that is currently selected is not a gray compensation profile, the processing advances to step S3103.

In step S3103, color determination threshold values To, Tm, and Tc are set so that Tc=cLow, Tm=mLow, and Ty=yLow, and then the processing advances to step S3105. On the other hand, in step S3104, color determination threshold values Tc, Tm, and Tc are set so that Tc=cHigh, Tm=mHigh, and Ty=yHigh, and then the processing advances to step S3105. Here, each of the color determination threshold values cLow, mLow, yLow, cHigh, mHigh, and yHigh is a constant that satisfies expressions (1), (2), and (3) at a value of a relatively low density of less than 16, for example, within a value range from 0 to 255.
cLow<cHigh (1)
mLow<mHigh (2)
yLow<yHigh (3)

Here, the color determination threshold value when the output profile is the gray compensation profile is larger than the color determination threshold value when the output profile is not the gray compensation profile. When the gray compensation profile is present, it is likely that a recording is intended by the color of gray. That is, the gray compensation profile is intended to avoid the determination that the page is a color page in the processing to be described below. To paraphrase this, when the output profile is not the gray compensation profile, it is intended that conditions for readily determining that the page is a color page are set. Note that at the time of issuing a print job by the host computer 2100, the gray compensation profile can be set during the print job by the instruction from the user. In addition, the gray compensation profile can be previously set by the user by using the operation unit 2012 of the document processing device 200. When the gray compensation profile is set during the print job, the gray compensation profile is set by the job ticket.

In step S3105, it is determined whether the object to be color-determined is of the image (halftone image) attribute. If, as a result of the determination, it is determined that the object to be color-determined is of the halftone image attribute, the processing advances to step S3106. On the other hand, if it is determined that the object to be color-determined is of an attribute other than the halftone image attribute, namely, of the graphics attribute and the character attribute, the processing advances to step S3108. In step S3106, it is determined whether pixel color values C, M, and Y of halftone image data are larger than the color determination threshold values Tc, Tm, and Ty. More specifically, it is determined whether any of expressions (4) through (6) described below is satisfied.
C>Tc (4)
M>Tm (5)
Y>Ty (6)
If, as a result of the determination, it is determined that the pixel color values C, M, and Y of the halftone image data are larger than the color determination threshold values Tc, Tm, and Ty, the processing advances to step S3109. On the other hand, if it is determined that the pixel color values C, M, and Y of the halftone image data are not larger than the color determination threshold values Tc, Tm, and Ty, the processing advances to step S3107. Then, in step S3107, it is determined whether the determination as to whether the color values C, M, and Y are larger than the color determination threshold values Tc, Tm, and Ty is made with respect to all the pixels of a focused object (halftone image). If, as a result of the determination, it is determined that the determination as to whether the color values C, M, and Y are larger than the color determination threshold values Tc, Tm, and Ty is made with respect to all the pixels of a focused object (halftone image), the processing advances to step S3110. If, as a result of the determination, it is determined that the determination as to whether the color values C, M, and Y are larger than the color determination threshold values Tc, Tm, and Ty is not made with respect to all the pixels of a focused object (halftone image), the processing returns to step S3106.

When the object to be color-determined is of the attribute other than the halftone image attribute and the processing advances to step S3108, the focused object is a graphic or a character. Instep S3108, it is determined whether the color values C, M, and Y that are used are larger than the color determination threshold values Tc, Tm, and Ty. More specifically, it is determined whether any of expressions (7) through (9) is satisfied.
C>Tc (7)
M>Tm (8)
Y>Ty (9)
If, as a result of the determination, it is determined that the color values C, M, and Y that are used are larger than the color determination threshold values Tc, Tm, and Ty, the processing advances to step S3109. On the other hand, if it is determined that the color values C, M, and Y that are used are not larger than the color determination threshold values Tc, Tm, and Ty, the processing advances to step S3110.

In step S3110, it is determined whether the color determination is performed on all the objects in the page. If, as a result of the determination, it is determined that the color determination is not performed on all the objects in the page, the processing advances to step S3112. In step S3112, the current page is determined to be a page whose color is not determined (being determined) yet, and then the processing ends. On the other hand, if it is determined that the color determination is performed on all the objects in the page, the processing advances to step S3111. In step S3111, the page is determined to be a monochromatic page, and the processing ends.

In addition, if, in step S3106 and step S3108, the color values C, M, and Y are determined to be larger than the color determination threshold values Tc, Tm, and Ty, the processing advances to step S3109. In step S3109, the current page is determined to be a color page, and the processing ends. Note that the result of determination as to whether the current page is a color page or a monochromatic page is stored in the RAM 2002 shown in FIG. 2 as an external variable. The result of determination is referred to by the print manager unit 1526 in order to determine which of the bitmap of a K plane only or the bitmap of each of the CMYK planes among the bitmaps of a CMYK plane produced by the renderer 3002 shown in FIG. 6 is used.

If it is determined to use the K plane only, printing is performed at a high speed by printing bitmap image data of black with a black toner or a black ink. In addition, if it is determined to use four planes of C, M, Y, and K, color printing with a high image quality is performed, although it takes longer in terms of time than in the case where printing is performed using the K plane only in a single color.

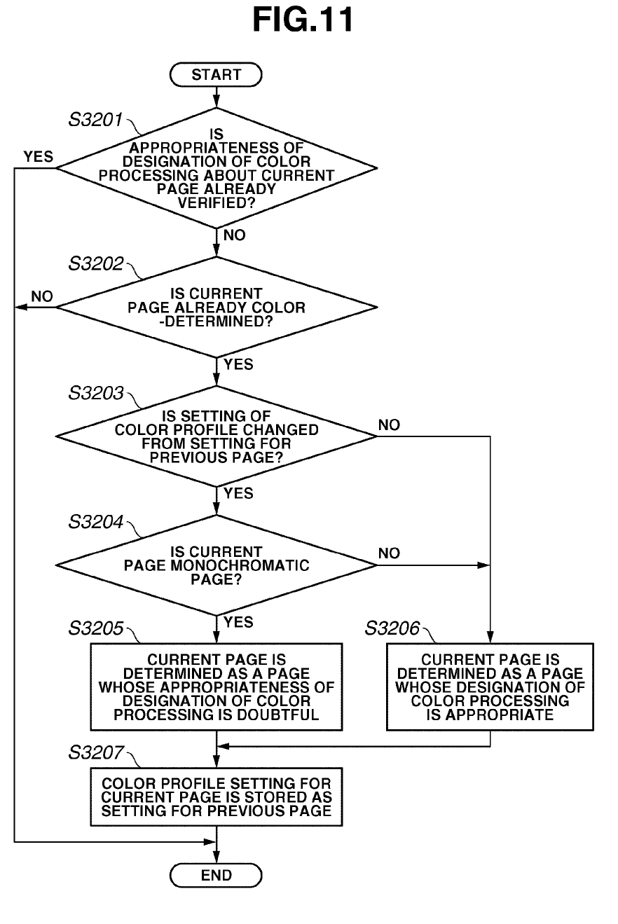

An example of a processing executed by the color-related preflight checking unit 3010 shown in FIG. 6 is described in more detail below with reference to the flow chart of FIG. 11. The color-related preflight checking processing shown in FIG. 11 is performed for each rendering object, just as in the case of the color determination processing shown in FIG. 10, and is called as a color-related preflight checking routine for each rendering object.

First, in step S3201, it is determined whether the appropriateness of the designation of the color processing about the current page is already verified. If, as a result of the determination, it is determined that the appropriateness of the designation of the color processing about the current page is already verified, the processing ends. On the other hand, if it is determined that the appropriateness of the designation of the color processing about the current page is not verified, the processing advances to step S3202. In step S3202, it is determined whether the color determination of the current page is already performed. The determination as to whether the color determination of the current page is already performed is made based on the result of the processing on the rendering object that is currently being processed as in the flow chart of FIG. 10. If, as a result of the determination, it is determined that the color determination for the current page is already performed, the processing advances to step S3203. On the other hand, if it is determined that the color determination for the current page is not performed, the processing ends.

In step S3203, it is determined whether the setting for the color profile is changed from a previous page. If, as a result of the determination, it is determined that the setting for the color profile is not changed from the previous page, the processing advances to step S3206. In step S3206, it is determined that the designation of the color processing about the current page is appropriate. That is, when the setting for the color profile is not changed from the content of the previous page, the color profile of the current page is determined to be appropriate regardless of any change in page description language data, namely, the color of each page of the document itself.

On the other hand, if it is determined that the setting for the color profile is changed from the previous page, the processing advances to step S3204. In step S3204, it is determined whether the result of the color determination about the current page indicates a monochromatic page. If, as a result of the determination, it is determined that the result of the color determination about the current page indicates a monochromatic page, the processing advances to step S3205. In step S3205, it is determined that the designation of the color processing about the current page is doubtful. Even when the setting for the color profile is changed for a monochromatic page, an image to be produced is not affected at all. That is, when the setting for the color profile is changed, it is likely that the user of the document processing device 200 supposes that the page to be processed is a color page. In this regard, in the present embodiment, the determination to the effect that the appropriateness of the print job is doubtful is made, in order to notify the user that the change in the setting for the color profile does not affect an image to be produced. On the other hand, if it is determined that the result of the color determination about the current page does not indicate a monochromatic page, the processing advances to step S3206. In step S3206, it is determined that the designation of the color processing about the current page is appropriate.

In the case where the processing advances to step S3205 or step S3206, the processing then advances to step S3207. In step S3207, the setting for the color profile about the current page is stored as the setting for the color profile about the previous page, and then the processing ends.

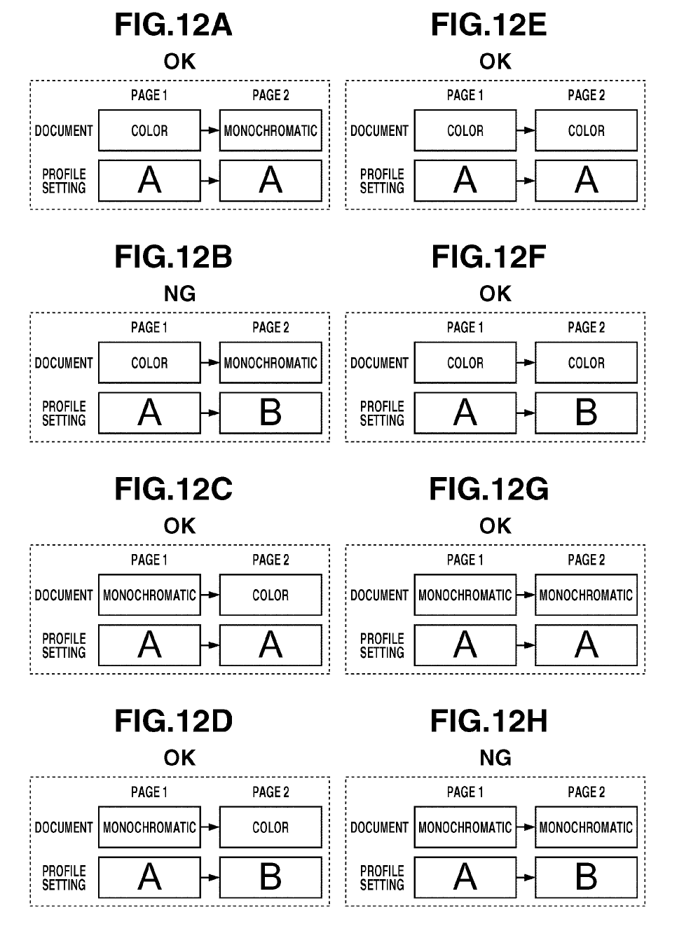

FIGS. 12A through 12H are diagrams illustrating an example of the result of the determination as to the appropriateness of the designation of the color processing. Eight determination examples shown in FIGS. 12A through 12H enumerate a combination in the case where the page description language data, namely, the color of a document and the setting for the color profile, changes between two consecutive pages. In the determination example shown in FIG. 12A, the designation of the color processing is determined to be appropriate. Likewise, in the determination examples shown in FIGS. 12C, 12E, 12G, the designation of the color processing is determined to be appropriate. In the example shown in FIG. 12A, the setting for the color profile is performed on a monochromatic page. In this regard, the setting for the color profile is often performed as a default setting on a device that can output images in color. Thus, the designation of the color processing is determined to be appropriate. In addition, even when the setting for the color profile is performed only on a page designated by the user, the setting for the color profile may be performed in a unified manner on a document in which a color page and a monochromatic page are present in a mixed manner.

In the determination examples shown in FIGS. 12B, 12D, 12F, and 12H, the setting for the color profile is changed between page 1 and page 2. However, when page 2 is a color page, the designation of the color processing is determined to be appropriate. On the other hand, when page 2 is a monochromatic page, the appropriateness of the designation of the color processing is determined to be doubtful. In the determination examples shown in FIG. 12A and FIG. 12B, a mismatch between the document and the setting occurs in page 2. However, the change in the setting for the color profile shows a clear desire of the user. Accordingly, the designation of the color processing is determined to be doubtful, which is more inappropriate than a simple mismatch between the document and the setting.

Note that in order to perform the determination as described above, a table as shown in FIG. 13 is stored in the ROM 2003, for example, so as to allow the color-related preflight checking unit 3010 to determine the appropriateness of the designation of the color processing with reference to the table.

As described above, in the present embodiment, the color determination unit 3009 determines whether the print data is a color page or a monochromatic page. The color-related preflight checking unit 3010 determines whether the setting for the color profile about the current page is changed from that about the previous page. If, as a result of the determination, it is determined that the setting for the color profile is not changed from that about the previous page, the designation of the color processing about the current page is determined to be appropriate.

On the other hand, if it is determined that the setting for the color profile is changed from that about the previous page, the color-related preflight checking unit 3010 determines whether the result of the color determination about the current page indicates a monochromatic page. If, as a result of the determination, it is determined that the result of the color determination about the current page indicates a monochromatic page, the appropriateness of the designation of the color processing about the current page is determined to be doubtful. If the result of the color determination about the current page is not determined to indicate a monochromatic page, the designation of the color processing about the current page is determined to be appropriate. Thus, when the appropriateness of the designation of the color processing is determined to be doubtful, the RIP processing is temporarily suspended, and then the warning to the effect that the doubtful job is input is displayed by the LCD provided on the operation unit 2012. The determination as to whether an ineffective change of the setting is performed between the pages is made in accordance with the result of determination of the relationship between the change in the print setting between pages and the print data between pages. When the ineffective change in the setting between pages is designated, the warning as to that effect is displayed. In this way, a printing out in a manner such that the user does not desire can be alleviated.

Note that in the present embodiment, the description is made as to the example in which the setting for the output profile is changed. However, even in the case where the setting for the related RGB source profile and the setting for the related CMYK simulation profile are changed in a page in which no RGB or CMYK rendering object is present, the checking in the same manner can be effectively performed. In addition, in the present embodiment, the description is made as to the example in which the appropriateness of the designation of the color processing is determined for each page. Thus, when the appropriateness of the designation of the color processing is doubtful in a mid-way portion of the page description language data that includes a plurality of pages, even if the job is cancelled, printing is performed up to the mid-way portion of the pages. For the method of alleviating this, there is a method in which the RIP processing for determining the appropriateness of the designation of the color processing in which printing is not performed is first performed and the printing starts only when the appropriateness is not doubtful. In order to implement this method, an image on which the RIP processing is already performed is temporarily stored in a storage medium such as the HDD 2004 and the printing is performed by using the image stored in the HDD 2004 at a stage at which the appropriateness of the designation of the color processing is completely made about all the pages, that is, at a stage at which the RIP processing is completed.

In addition, there is another method in which first, all the page description language data are temporarily spooled and the RIP processing for determining the appropriateness of the designation of the color processing is first performed. In this case, all the produced display lists are abandoned so as not to perform the rendering processing. Then, the RIP processing is performed again for the printing by using the spooled page description language data, only when the designation of the color processing is appropriate so as to perform the printing. In the method in which an image on which the RIP processing is already performed is stored in the HDD 2004, the time taken for printing can be shortened, but a large-capacity HDD is necessary. This is because an image on which the RIP processing is already performed needs a larger capacity than the page description language data. As described above, there are advantages and disadvantages in both of the methods. Accordingly, the methods may be selectively applied in accordance with a purpose of the printing.

Note that the method according to the present embodiment can be applied to a system that includes a plurality of devices (for example, a host computer, an interface device, a scanner, and a printer) or can be applied to an apparatus including a printer only.

Second Exemplary embodiment

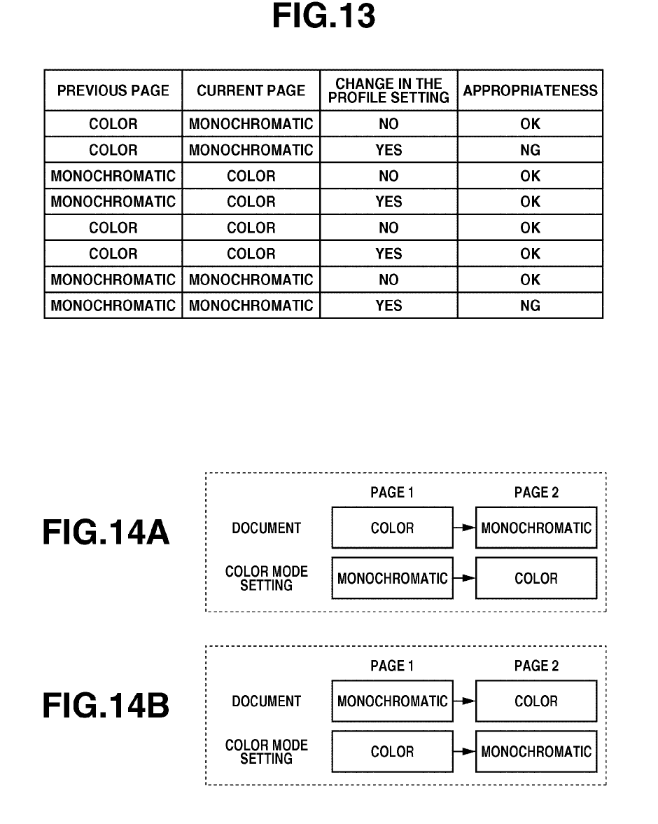

A second exemplary embodiment of the present invention is described next. In the first exemplary embodiment described above, the appropriateness of the job is verified based on the fact that an image produced by the RIP processing is not changed although the designation of the color processing (the color setting) by the job ticket is changed between pages. However, there is a case where the appropriateness is doubtful although an image produced by the RIP processing is changed. For example, examples shown in FIG. 14A and FIG. 14B correspond to such a case. The two examples shown in FIG. 14A and FIG. 14B indicate a combination in which the page description language data, namely, the color of a document and the setting for a color profile, change between two consecutive pages.

In the example shown in FIG. 14A, the setting for a color mode is changed from monochromatic to color at a section of the document in which the document changes from a color page to a monochromatic page. In this case, the reproduction is performed by using four colors of toners of C, M, Y, and K, while performing the color processing on the monochromatic page of the document. In this way, indeed, a reproduction performance improves compared to the case where the reproduction is performed by using a single color toner of K. However, considering that the color page that is a previous page is processed by performing the setting for the color mode to be monochromatic, it is unlikely that the above setting is intentionally performed.

In the example shown in FIG. 14B, contrary to the example shown in FIG. 14A, the setting for the color mode is changed from color to monochromatic at a section of the document in which the document changes from a monochromatic page to a color page. In this case also, the two pages are reproduced in a gray gradation at a glance. However, page 1 is reproduced by using four colors of toners of C, M, Y, and K, and on the contrary, page 2 is reproduced by using a single color toner of K. Thus, when page 1 and page 2 are observed at the same time, there remains a sense of incongruity between the two pages.

In the first exemplary embodiment, the clearly ineffective setting by which an image produced by the RIP processing is not changed is determined. On the contrary, In the examples shown in FIGS. 14A and 14B, although it is clear that the setting is unnatural, since an image produced by the RIP processing is changed, the setting is not determined to be clearly ineffective. This is the difference from the first exemplary embodiment. In this regard, in the second exemplary embodiment, the description is made as to a case where a page that is not determined to be clearly ineffective but unnatural is determined, as shown in FIGS. 14A and 14B. Thus, the second exemplary embodiment differs from the first exemplary embodiment in one part of the method of determining the appropriateness of the job. Thus, the same or similar portions as in the first exemplary embodiment are provided with the same reference numerals and symbols as those shown in FIGS. 1 through 13, and a detailed description thereof is not repeated here.

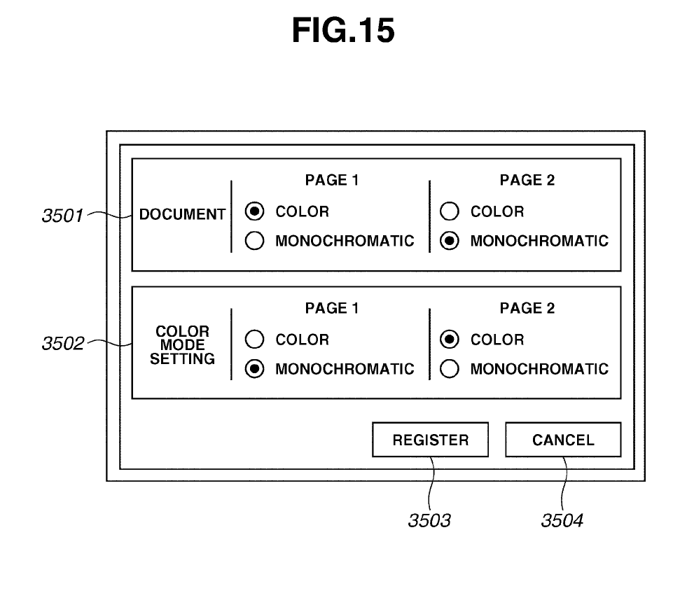

FIG. 15 is a diagram illustrating an example of a screen displayed by the LCD provided on the operation unit 2012. The screen is used to register a case to be detected in determining the appropriateness of a job. A document pane 3501 is a portion for performing a registration as to whether the page is color or monochromatic with respect to each of page 1 and page 2 of the document. The selection between color and monochromatic can be made by pressing a radio button, for only one mode from among the color and monochromatic modes. A color mode setting pane 3502 is a portion for performing a registration as to the color mode setting for each of page 1 and page 2. The selection for the registration can be made between color and monochromatic. The combination of the color of two consecutive pages of the document and the color mode setting registered via the screen is determined as the combination whose appropriateness of the job is doubtful. In this case, the appropriateness of the job is determined only when the case is previously registered. Accordingly, in an initial state, the appropriateness of the job is not determined. Note that the combination that is registered via the screen is stored in the RAM 2002 shown in FIG. 2 as an external variable, and is referred to by an execution module of the preflight checking, which is to be described below.

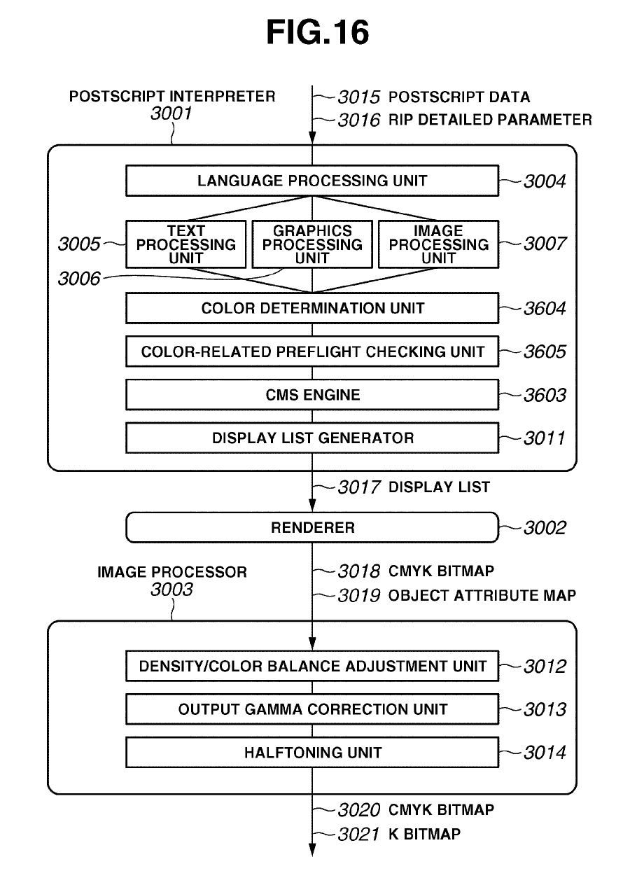

FIG. 16 is a diagram schematically illustrating the flow of the RIP processing for interpreting a page description language and forming an image. Compared to the example shown in FIG. 6, the sequence of the color determination unit, the color-related preflight checking unit, and the CMS engine only is different, and other portions are similar to the flow of the processing by the document processing device 200 according to the first exemplary embodiment. The above sequence is different because when the color mode setting is set to be monochromatic, all the colors are color-converted into one color of K by a CMS engine 3603, and when the color mode setting is set to be color, all the colors are color-converted into four colors of C, M, Y, and K. Therefore, even if the color determination is performed at a stage after the CMS engine 3603, the page description language data, namely, the color of each page of the original document, cannot be determined. In this regard, the color determination for each page is performed by a color determination unit 3604 before performing the color conversion by the CMS engine 3603, and the determination as to the appropriateness of the designation of the color processing is made by a color-related preflight checking unit 3605 based on the result of the color determination.

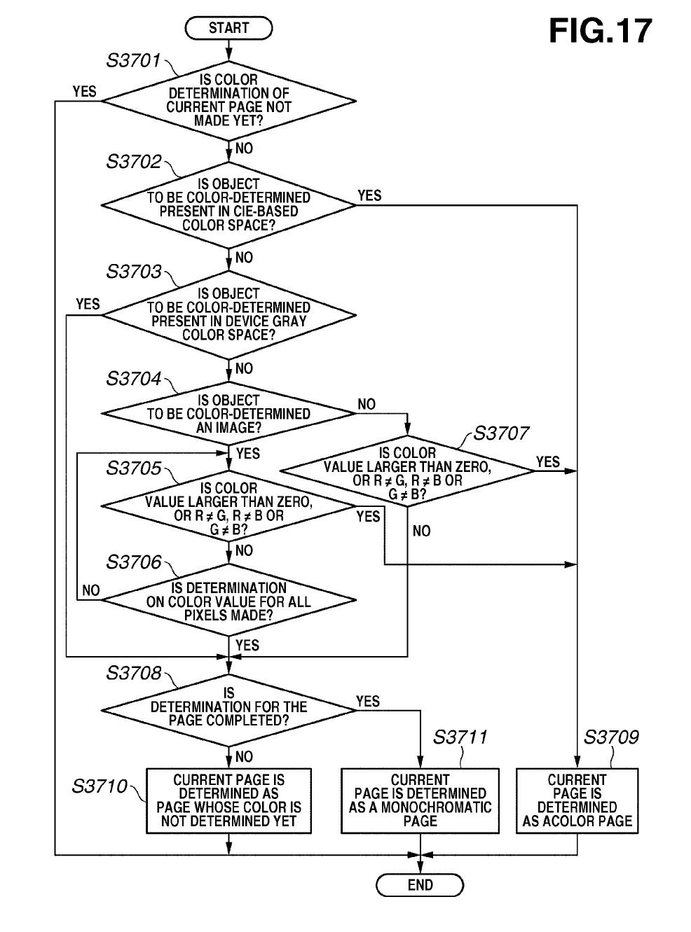

An example of a processing executed by the color determination unit 3604 shown in FIG. 16 is described in more detail below with reference to the flowchart of FIG. 17. First, in step S3701, it is determined whether the color determination of the current page is not made yet. If, as a result of the determination, it is determined that the color determination of the current page is already made to be color or monochromatic, the color determination is not performed and the processing ends. On the other hand, If, as a result of the determination, it is determined that the color determination of the current page is not made yet, the processing advances to step S3702. In step S3702, it is determined whether a rendering object to be color-determined is color-designated in the CIE-based color space. If, as a result of the determination, it is determined that the rendering object to be color-determined is color-designated in the CIE-based color space, the processing advances to step S3709. On the other hand, if it is determined that the rendering object to be color-determined is not color-designated in the CIE-based color space, the processing advances to step S3703.

In step S3703, it is determined whether the rendering object to be color-determined is color-designated in the Device Gray color space. If, as a result of the determination, it is determined that the rendering object to be color-determined is color-designated in the Device Gray color space, the processing advances to step S3708. On the other hand, if it is determined that the rendering object to be color-determined is not color-designated in the Device Gray color space, the processing advances to step S3704. In step S3704, it is determined whether the rendering object to be color-determined is of the image (halftone image) attribute. If, as a result of the determination, it is determined that the rendering object to be color-determined is of the halftone image attribute, the processing advances to step S3705. On the other hand, if it is determined that the object to be color-determined is of the attribute other than the halftone image attribute, namely, the graphics attribute or the text attribute, the processing advances to step S3707.

In step S3705, it is determined whether any one of the pixel color values C, M, and Y of the halftone image data is larger than zero, or whether all of an R signal, a G signal, and a B signal are not of the same value. More specifically, the determination is made as to whether any one of expressions (10) through (15) is satisfied.
C>0 (10)
M>0 (11)
Y>0 (12)
R≠G (13)
R≠B (14)
G≠B (15)

If, as a result of the determination, it is determined that any one of the pixel color values C, M, and Y of the halftone image data is larger than zero, or that all of the R signal, the G signal, and the B signal are not of the same value, the processing advances to step S3709. On the other hand, if it is determined that all of the pixel color values C, M, and Y of the halftone image data are not larger than zero, or that all of the R signal, the G signal, and the B signal are of the same value, the processing advances to step S3706. In step S3706, it is determined whether the determination as to whether any one of the pixel color values C, M, and Y of the halftone image data is larger than zero, or whether all of the R signal, the G signal, and the B signal are not of the same value, is made with respect to all pixels of the focused object (halftone image). If, as a result of the determination, it is determined that the determination as to whether any one of the pixel color values C, M, and Y of the halftone image data is larger than zero, or whether all of the R signal, the G signal, and the B signal are not of the same value, is made with respect to all pixels of the focused object (halftone image), the processing advances to step S3708. On the other hand, if it is determined that the determination as to whether any one of the pixel color values C, M, and Y of the halftone image data is larger than zero, or whether all of the R signal, the G signal, and the B signal are not of the same value, is not made with respect to all the pixels of the focused object (halftone image), the processing returns to step S3705.

In addition, when the object to be color-determined is an object other than the object of the halftone image attribute and the processing advances to step S3707, the focused object is of the graphic or text attribute. Therefore, the determination is made as to whether any one of the pixel color values C, M, and Y to be used is larger than zero, or whether all of the R signal, the G signal, and the B signal are not of the same value. More specifically, the determination is made as to whether any one of expressions (16) through (21) is satisfied.
C>0 (16)
M>0 (17)
Y>0 (18)
R≠G (19)
R≠B (20)
G≠B (21)
If, as a result of the determination, it is determined that any one of the pixel color values C, M, and Y to be used is larger than zero, or that all of the R signal, the G signal, and the B signal are not of the same value, the processing advances to step S3709. On the other hand, if it is determined that all of the pixel color values C, M, and Y to be used are not larger than zero, or that all of the R signal, the G signal, and the B signal are of the same value, the processing advances to step S3708.

In step S3708, it is determined whether the color determination is performed on all of the objects in the page. If, as a result of the determination, it is determined that the color determination is not performed on all of the objects in the page, the processing advances to step S3710. In step S3710, it is determined that the current page is not yet color-determined (being color-determined) and the processing ends. On the other hand, if it is determined that the color determination is performed on all of the objects in the page, the processing advances to step S3711. In step S3711, the current page is determined to be monochromatic and the processing ends. In addition, if, in step S3705 or S3707, it is determined that any one of the pixel color values C, M, and Y is larger than zero, or that all of the R signal, the G signal, and the B signal are not of the same value, the processing advances to step S3709. In step S3709, the current page is determined to be color and the processing ends.

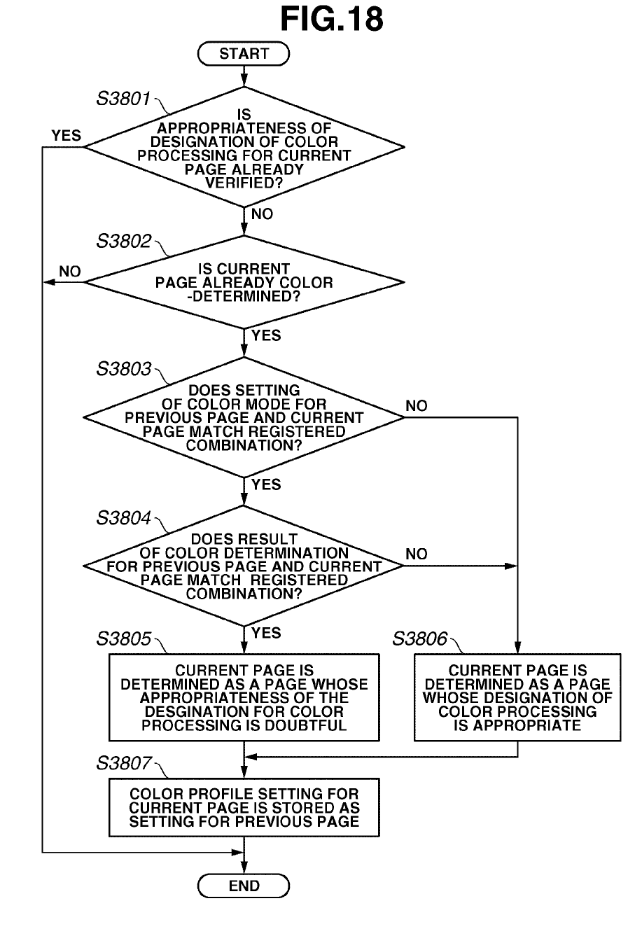

An example of a processing executed by the color-related preflight checking unit 3605 shown in FIG. 16 is described in more detail below with reference to the flow chart of FIG. 18. First, in step S3801, it is determined whether the verification as to the appropriateness of designation of the color processing about the current page is performed. If, as a result of the processing, it is determined that the verification as to the appropriateness of designation of the color processing about the current page is already performed, the processing ends. On the other hand, if it is determined that the verification as to the appropriateness of designation of the color processing about the current page is not performed yet, the processing advances to step S3802. In step S3802, it is determined whether the current page is already color-determined. The determination as to whether the color determination of the current page is already performed is made based on the result of the processing on the rendering object that is currently being processed in the flow chart of FIG. 17. If, as a result of the determination, it is determined that the color determination for the current page is already performed, the processing advances to step S3803. On the other hand, if it is determined that the color determination for the current page is not performed yet, the processing ends.

In step S3803, it is determined whether the setting of the color mode for the previous page and the current page matches the combination that is registered via the screen shown in FIG. 15. If, as a result of the determination, it is determined that the setting of the color mode for the previous page and the current page matches the combination that is registered via the screen shown in FIG. 15, the processing advances to step S3804. On the other hand, if it is determined that the setting of the color mode for the previous page and the current page does not match the combination that is registered via the screen shown in FIG. 15, the processing advances to step S3806. In step S3806, the current page is determined to be appropriate.

In step S3804, it is determined whether the result of the color determination for the previous page and the current page matches the combination that is registered via the screen shown in FIG. 15. If, as a result of the determination, it is determined that the result of the color determination for the previous page and the current page matches the combination that is registered via the screen shown in FIG. 15, the processing advances to step S3805. In step S3805, it is determined that the appropriateness of the current page is doubtful. On the other hand, if it is determined that the result of the color determination for the previous page and the current page does not match the combination that is registered via the screen shown in FIG. 15, the processing advances to step S3806. In step S3806, the current page is determined to be appropriate. In the case where the processing advances to step S3805 or step S3806, the processing then advances to step S3807. In step S3807, the setting for the color profile about the current page is stored as the setting for the color profile about the previous page, and then the processing ends.

Note that in the present embodiment, the description is made as to the example in which it is determined whether the change in the color profile is made between the previous page and the current page. However, when it is determined whether the ineffective setting is designated between pages (that is, whether the setting that the user does not intend is designated) and the ineffective setting between pages is designated, any configuration may be applied as far as the warning as to that effect is notified to the user. For example, although the page size is changed from size A4 to size A3 between the previous and the current pages, when the setting for two-sided printing is instructed for the current page, the warning as to that effect can be notified to the user. In addition, for example, although the page size is changed between the previous and the current pages, when the setting for number-up (N-up) printing is instructed, the warning as to that effect can be notified to the user.

In this case, instead of the color determination as described in FIG. 17, the page size of the current page is determined. In addition, instead of the preflight checking as described in FIG. 18, first, it is determined whether the verification as to whether no discrepancy is included in the print setting for the current page is already performed. Then, the page size of the current page is determined. Then, it is determined whether the two-sided printing or the N-up printing is set. If the two-sided printing or the N-up printing is determined to be set as a result of the determination, it is determined that there is a discrepancy in the print setting for the current page. On the other hand, the two-sided printing is not determined to be set, it is determined that there is no discrepancy in the print setting for the current page. Note that in this case also, it is desirable that a table for determining the appropriateness of the job is previously produced so as to determine the appropriateness of the job with reference to the table.

Third Exemplary embodiment

A third exemplary embodiment of the present invention is described below. In the first and the second exemplary embodiments, the document processing device (printer) performs the determination as to the appropriateness of the designation of the color processing (the color-related preflight checking). In the third exemplary embodiment, the determination as to the appropriateness of the designation of the color processing is performed by a printer driver that is set in the host computer. As described above, the third exemplary embodiment differs from the first and the second exemplary embodiments only with respect to the device that performs the processing. Therefore, in the description of the present embodiment, the same or similar portions as in the first exemplary embodiment and the second exemplary embodiment are provided with the same reference numerals and symbols as those shown in FIGS. 1 through 18, and a detailed description thereof is not repeated here. Note that in the present embodiment, the description is made as to an example in which a PostScript printer driver is used as the printer driver.

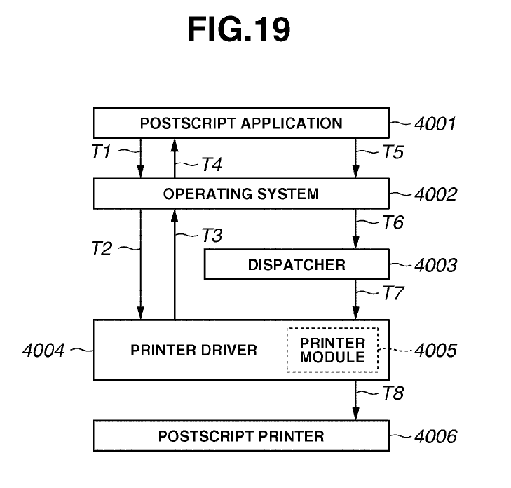

FIG. 19 is a diagram illustrating an example of a flow from the issuance of a print instruction to the application by the user to the printing operation. Referring to FIG. 19, all of the modules except a PostScript printer 4006 operate on the host computer 2100 shown in FIG. 1. The PostScript printer 4006 is equivalent to the document processing device 200 shown in FIG. 1. First, the user generates an instruction for printing with the operation of the keyboard or the mouse provided on the host computer 2100. Then, at a timing T1, a PostScript application 4001 issues an inquiry to an operating system 4002 in order to determine whether a printer driver 4004 is the printer driver that supports the PostScript. The operating system 4002, in response to the inquiry from the PostScript application 4001, issues an inquiry to the printer driver 4004 at a timing T2.

Here, at a timing T3, the printer driver 4004 replies that the printer driver is the PostScript printer driver. Then, at a timing T4, the operating system 4002 replies to the PostScript application 4001 that the type of the printer driver 4004 is the PostScript printer driver. Then, the PostScript application 4001 recognizes that the printer driver 4004 is the PostScript printer driver, and accordingly, the PostScript application 4001 produces PostScript data at a timing T5. The PostScript data is sent to the printer driver 4004 via the operating system 4002 and a dispatcher 4003 at a timing T6 and a timing T7. In an ordinary case, the PostScript data is directly sent to the PostScript printer 4006 at a timing T8. However, the printer driver 4004 according to the present embodiment performs the determination as to the appropriateness of the setting for the designation of the color processing by using a preflight module 4005.

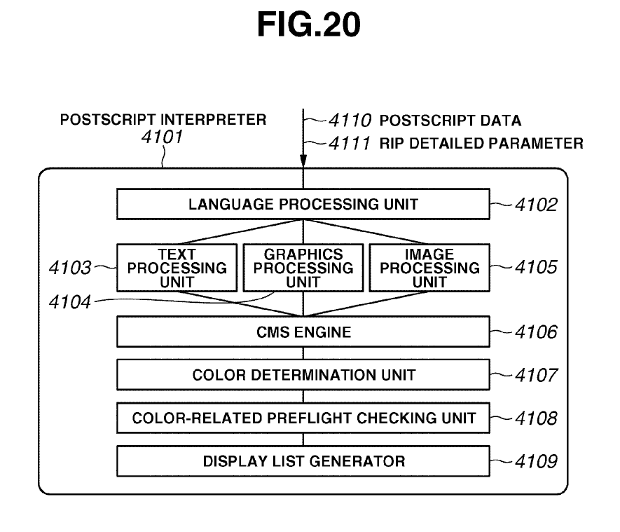

FIG. 20 is a diagram illustrating an example of a configuration of the preflight module 4005 for determining the appropriateness of the setting for the designation of the color processing. In the present embodiment, the data whose appropriateness of the designation of the color processing is determined is PostScript data. Therefore, just as in the first exemplary embodiment as described above, the appropriateness of the designation of the color processing is determined by using a PostScript interpreter 4101. Here, there are two points in the present embodiment that differ from the first exemplary embodiment. Firstly, the third exemplary embodiment differs from the first exemplary embodiment in the point that the value set by the user interface (UI) of the printer driver 4004 is transmitted as it is as an RIP detailed parameter 4111. Secondly, the third exemplary embodiment differs from the first exemplary embodiment in the point that a display list generator 4109 does not perform the processing for outputting the display list. Each of a language processing unit 4102, a text processing unit 4103, a graphics processing unit 4104, an image processing unit 4105, a CMS engine 4106, a color determination unit 4107, and a color-related preflight checking unit 4108 performs the same or similar processing as that described with reference to FIG. 6, FIG. 10, and FIG. 11. Accordingly, a detailed description thereof is not repeated here.

If the preflight module 4005 as described above determines that the appropriateness of the designation of the color processing is doubtful, the UI of the printer driver 4004 displays the same dialog as that shown in FIG. 9 so as to wait for an instruction from the user, as in the first exemplary embodiment.

In addition, for an application of a form similar to the PostScript printer driver, there is a hot folder that sends a job by using a shared folder. When the hot folder is used, the preflight checking for determining the mismatch between the designation of the color processing and the print data can be performed in the same manner as described above.

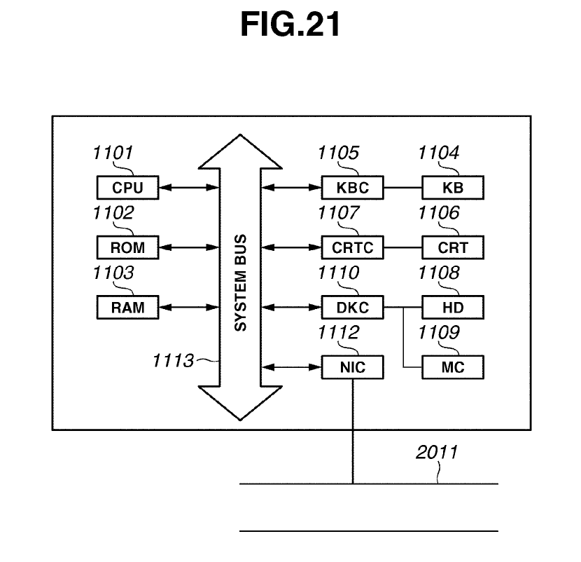

Note that in the first through the third exemplary embodiments described above, the host computer 2100 has a configuration such as that shown in FIG. 21, for example. Referring to FIG. 21, a CPU 1101, a ROM 1102, a RAM 1103, and a keyboard controller (KBC) 1105 of a keyboard (KB) 1104 are connected to a system bus 1113. In addition, a CRT controller (CRTC) 1107 of a CRT display (CRT) 1106, which is a display unit, and a controller (DKC) 1110 of a hard disk (HD) 1108 and a recording medium (MC) 1109 are connected to the system bus 1113. In addition, a network interface controller (NIC) 1112 for connection to the LAN 2011 is connected to the system bus 1113. As described above, each portion shown in FIG. 21 is mutually connected in a communicable manner via the system bus 1113.

The CPU 1101 controls each component that is connected to the system bus 1113, by implementing software that is stored in the ROM 1102 or the HD 1108. That is, the CPU 1101 performs the control for implementing the operation as described above, by reading a processing program and data that conform to a given processing sequence from the ROM 1102, the HD 1108, or the recording medium (MC) 1109 and implementing the read processing program and data.

The RAM 1103 functions as a main memory or a work area of the CPU 1101. The KBC 1105 controls an input of the instruction from the user interface such as a pointing device including the KB 1104 and the mouse.

The CRTC 1107 controls the CRT 1106, which has a function as a graphic user interface. The DKC 1110 controls an access to the HD 1108 or the recording medium (MC) 1109, which stores a given processing program such as a boot program, various kinds of applications, an editing file, a user file, and a network management program. The NIC 1112 sends and receives data interactively to and from a device or a system on the LAN 2011.

Other Exemplary Embodiments

An aspect of the present invention can also be achieved such that each kind of device operates so as to implement the functions of the above-described embodiments by providing a computer within an apparatus or system connected to each kind of device with program code of software implementing the functions of the above-described embodiments and by reading and executing the program code stored in the computer of the system or apparatus (a CPU or an MPU). In this case, the program code itself implements the functions of the above-described embodiments, and accordingly, the program code itself and a medium for supplying the program code with the computer, for example, a storage medium storing the program code, constitute the present invention.

As the storage medium for supplying such program code, a flexible disk, a hard disk, an optical disk, a magneto-optical disk, a CD-ROM, a magnetic tape, a nonvolatile memory card, and a ROM can be used.

In addition, the functions of the above-described embodiments are implemented not only by executing the program code read by the computer, but also implemented by the processing in which an OS (operating system) or a combination of the OS and other application software carries out a part of or the whole of the actual processing based on the instruction given by the program code.

Further, in another aspect of an embodiment of the present invention, after the supplied program code is written in a memory provided in a function expansion board inserted in a computer or a function expansion unit connected to the computer, a CPU and the like provided in the function expansion board or the function expansion unit carries out a part of or the whole of the processing to implement the functions of the above-described embodiments.

According to an exemplary embodiment of the present invention, it is determined whether there is a discrepancy in the relationship between print data and a change in the print setting that is made in a mid-way portion of the print data. Then, a message to that effect is notified to a user. Thus, the user can be notified in advance that the print data may be output in a form that the user does not intend. Accordingly, the print data can be prevented from being output in a form that the user does not intend.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-300782 filed Oct. 14, 2005, which is hereby incorporated by reference herein in its entirety.

What is claimed is:

1. An apparatus comprising:
an analysis unit configured to analyze a content of change in a print setting when a change in the print setting is set between pages of print data;
a determination unit configured to determine whether there is a discrepancy in a relationship between the content of change in the print setting and the associated pages of the print data; and
a notification unit configured to notify a warning indicating the change to a user if it is determined that there is a discrepancy in the relationship between the content of change in the print setting and the associated pages of the print data.

2. The apparatus according to claim 1, further comprising a receiving unit configured to receive, after the notification unit notifies the warning to the user, an instruction from the user as to whether to continue processing for outputting the print data.

3. The apparatus according to claim 2, further comprising an output unit configured to perform processing for outputting the print data,
wherein the output unit stops the processing for outputting the print data when the receiving unit receives an instruction for discontinuing the processing for outputting the print data.

4. The apparatus according to claim 1, wherein the determination unit determines that there is no discrepancy in the relationship between the content of change in the print setting analyzed by the analysis unit and the associated pages of the print data if a result of outputting of the print data changes due to the change in the print setting, and wherein the determination unit determines that there is a discrepancy in the relationship between the content of change in the print setting analyzed by the analysis unit and the associated pages of the print data if a result of outputting of the print data does not change due to the change in the print setting.

5. The apparatus according to claim 1, further comprising a table stored on a storage medium, the table representing information on a print setting about two consecutive pages and associated information on print data of the two consecutive pages,
wherein the determination unit uses the table to determine whether there is a discrepancy in the relationship between the content of change in the print setting and the associated pages of the print data.

6. The apparatus according to claim 1, further comprising an acquiring unit configured to acquire, from an external device, a job ticket including information on the print setting,
wherein the analysis unit analyzes the content of change in the print setting set between pages of the print data based on the information on the print setting included in the job ticket acquired by the acquiring unit.

7. The apparatus according to claim 1, further comprising a storage unit configured to store, if it is determined that there is a discrepancy in the relationship between the content of change in the print setting and the associated pages of the print data, a history of results of the determination on a storage medium.

8. The apparatus according to claim 1, wherein the analysis unit, the determination unit and the notification unit are included in a document processing device.

9. The apparatus according to claim 1, wherein the analysis unit and the determination unit are incorporated in a printer driver of an information processing apparatus.

10. A method comprising:
analyzing a content of change in a print setting when a change in the print setting is set between pages of print data;
determining whether there is a discrepancy in a relationship between the content of change in the print setting analyzed and the associated pages of the print data; and
notifying a warning indicating the change to a user if it is determined that there is a discrepancy in the relationship between the content of change in the print setting and the associated pages of the print data.

11. The method according to claim 10, further comprising:
receiving an instruction from the user indicating whether or not to continue processing the print data for printing the print data after the warning has been notified to the user.

12. A machine-readable medium storing instructions which, when executed by a machine, causes the machine to perform operations comprising:
analyzing a content of change in a print setting when a change in the print setting is set between pages of print data;
determining whether there is a discrepancy in a relationship between the content of change in the print setting analyzed and the associated pages of the print data; and
notifying a warning indicating the change to a user if it is determined that there is a discrepancy in the relationship between the content of change in the print setting and the associated pages of the print data.

13. The machine-readable medium according to claim 12, wherein the operations further comprises:
receiving an instruction from the user indicating whether or not to continue processing the print data for printing the print data after the warning has been notified to the user.

14. A method comprising:
determining if a first color setting set for a first page of print data is different from a second color setting set for a second page of the print data;
determining if the second page of the print data corresponds to a monochromatic page; and
inquiring a user whether or not to proceed with execution of printing of the print data if the first color setting is different from the second color setting and the second page is determined to be a monochromatic page.

15. The method according to claim 14, further comprising:
receiving an instruction from the user indicating whether or not to proceed with execution of printing of the print data in response to the inquiry.

16. An apparatus comprising:
an analysis unit configured to analyze a first print setting of a first page of print data and a second print setting of a second page of the print data, when the first print setting is different from the second print setting, to determine if there is a discrepancy between the first and second print settings and the associated pages of the print data; and
a notification unit configured to notify the discrepancy to a user if it is determined that there is a discrepancy between the first and second print settings and the associated pages of the print data.
